(19) United States
(12) Patent Application Publication
(10) Pub. No.: US 2014/0003723 A1
(43) Pub. Date: Jan. 2, 2014

(54) Text Detection Devices and Text Detection Methods

(71) Applicant: Agency for Science, Technology and Research, Singapore (SG)

(72) Inventors: Shijian LU, Singapore (SG); Joo Hwee LIM, Singapore (SG)

(73) Assignee: Agency for Science, Technology and Research, Singapore (SG)

(21) Appl. No.: 13/924,920

(22) Filed: Jun. 24, 2013

(30) Foreign Application Priority Data
Jun. 27, 2012 (SG) SG201204779-1

(51) Int. Cl. G06K 9/18

(52) U.S. Cl. CPC G06K 9/18
USPC 382/182

(57) ABSTRACT

A text detection device is provided. The text detection device may include: an image input circuit configured to receive an image; an edge property determination circuit configured to determine a plurality of edge properties for each of a plurality of scales of the image; and a text location determination circuit configured to determine a text location in the image based on the plurality of edge properties for the plurality of scales of the image.

### CROSS-REFERENCE TO RELATED APPLICATIONS

The present application claims the benefit of priority of SG application No. 201204779-1 filed on Jun. 27, 2012, the contents of which are incorporated herein by reference for all purposes.

### TECHNICAL FIELD

Embodiments relate generally to text detection devices and text detection methods.

### BACKGROUND

Detecting text from scene images is an important task for a number of computer vision applications. By recognizing the detected scene text many of which are often related to the names of roads, buildings, and other landmarks, users may get to know a new environment quickly. In addition, scene text may be related to certain navigation instructions that may be helpful for autonomous navigation applications such as unmanned vehicle navigation and robotic navigation in urban environments. Furthermore, semantic information may be derived from the detected scene text which may be useful for the content-based image retrieval. Thus, there may be a need for reliable and efficient text detection from scene images.

### SUMMARY

According to various embodiments, a text detection device may be provided. The text detection device may include: an image input circuit configured to receive an image; an edge property determination circuit configured to determine a plurality of edge properties for each of a plurality of scales of the image; and a text location determination circuit configured to determine a text location in the image based on the plurality of edge properties for the plurality of scales of the image.

According to various embodiments, a text detection method may be provided. The text detection method may include: receiving an image; determining a plurality of edge properties for each of a plurality of scales of the image; and determining a text location in the image based on the plurality of edge properties for the plurality of scales of the image.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1A shows a text detection device in accordance with an embodiment;

FIG. 1B shows a text detection device in accordance with an embodiment;

FIG. 1C shows a text detection method in accordance with an embodiment;

FIG. 2A shows a sample natural image with text;

FIG. 2B shows a further sample natural image with text;

FIG. 3 shows a framework of the scene text detection system devices and methods according to various embodiments;

FIG. 4A shows the determined first feature image of the first edge gradient feature (for red color component image at original scale) for the sample image of FIG. 2B;

FIG. 4B shows the determined second feature image of the second stroke width feature (for red color component image at original scale) for the sample image of FIG. 2B;

FIG. 5A shows the determined third feature image of the third edge openness feature (for red color component image at original scale) for the sample image of FIG. 2B.

FIG. 5B shows the determined fourth feature image of the fourth edge aspect ratio feature (for red color component image at original scale) for the sample image of FIG. 2B;

FIG. 6A shows the fifth feature image of the fifth edge enclosing feature (for red color component image at original scale) for the sample image in FIG. 2B;

FIG. 6B shows the sixth feature image of the six edge count feature (for red color component image at original scale) for the sample image of FIG. 2B;

FIG. 6C further illustrates the fifth edge enclosing feature as shown in FIG. 6A in a blackboard representation;

FIG. 7A shows the determined feature image, for example the edge feature image at one specific scale (for red color component image at original scale) for the sample image in FIG. 2B, where text edges are kept properly whereas non-text edges are suppressed properly;

FIG. 7B shows the final determined text probability map for the sample image of FIG. 2B;

FIG. 8A illustrates the edge feature image at one specific scale and shows a diagram illustrating the P1 for the text probability map shown in FIG. 7B;

FIG. 8B shows the final determined text probability map (for example shown as a blackboard model illustration) and shows an illustration of the filtered binary edge components for the detected text lines shown in FIG. 8A;

FIG. 8C shows the final determined text probability map in a white board illustration;

FIG. 9 shows an illustration of the results of devices and methods according to various embodiments, with several natural images in a benchmarking dataset; and

FIG. 10 shows a further illustration of devices and methods according to various embodiments, with several natural images in a benchmarking (publicly available) dataset.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

In this context, the text detection device as described in this description may include a memory, which is for example used in the processing carried out in the text detection device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions, which will be described in more detail below may also be understood as a “circuit” in accordance with an alternative embodiment.

Text may convey high-level semantics unique to humans in communication with others and the environment. Although there may be good solutions for OCR (optical character recognition) on localized text, unconstrained text detection is a unique human intelligent function, which is still very hard for machines.

According to various embodiments, an accurate scene text detection technique may be provided that may make use of image edges within a blackboard or (whiteboard) architectural model. According to various embodiments, various edge features (which may also be referred to as edge properties), for example six edge features, as knowledge sources may first be extracted from each color component image at each specific scale each of which may capture one text-specific image/shape characteristics. The extracted edge features may then be combined into a text probability map by several integration strategies where edges of scene text may be enhanced whereas those of non-text objects may be suppressed consistently. Finally, scene text may be located within the constructed text probability map through the incorporation of knowledge of text layout. The devices and methods according to various embodiments have been evaluated over a public benchmarking dataset and good performance has been achieved. The devices and methods according to various embodiments may be used in different applications such as human computer interaction, autonomous robot navigation and business intelligence.

According to various embodiments, devices and methods for accurate scene text detection through structural image edge analysis may be provided.

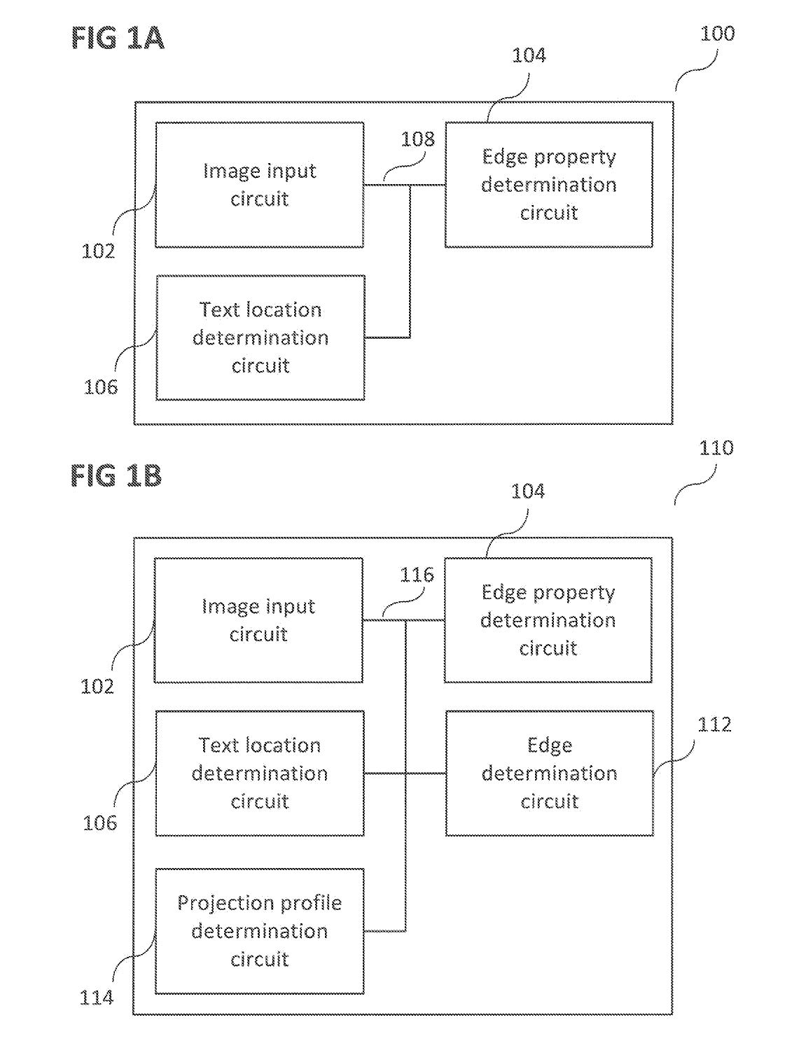

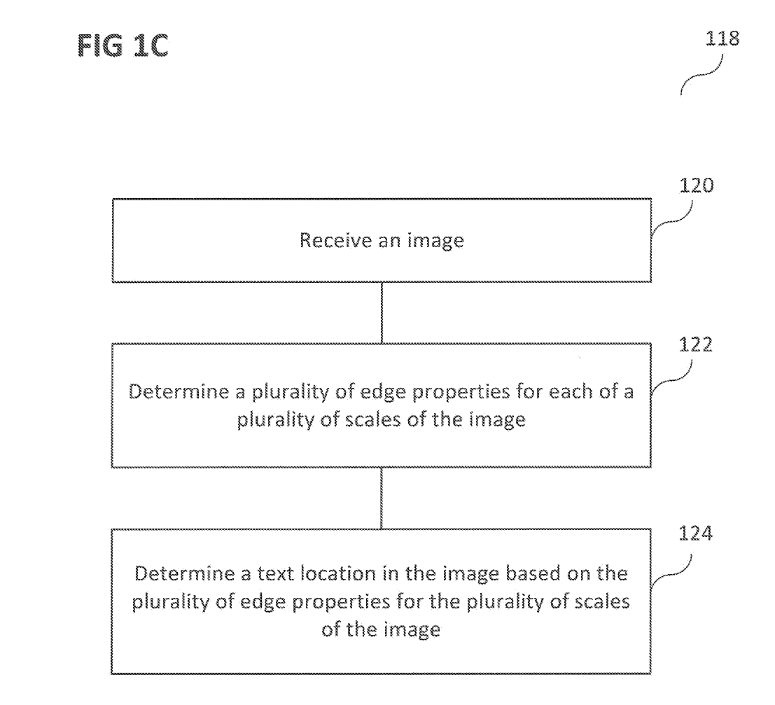

FIG. 1A shows a text detection device 100 according to various embodiments. The text detection device 100 may include an image input circuit 102 configured to receive an image. The text detection device 100 may further include an edge property determination circuit 104 configured to determine a plurality of edge properties for each of a plurality of scales of the image. The text detection device 100 may further include a text location determination circuit 106 configured to determine a text location in the image based on the plurality of edge properties for the plurality of scales of the image. The image input circuit 102, the edge property determination circuit 104, and the text location determination circuit 106 may be coupled with each other, for example via a connection 108, for example an optical connection or an electrical connection, such as for example a cable or a computer bus or via any other suitable electrical connection to exchange electrical signals.

In other words, an image may be input to the text detection device. Then, for a plurality of scales of the input image, the text detection device may determine a plurality of edge properties (for example, a plurality of edge properties may be determined for a first scale of the image, and a plurality of edge properties may be determined for a second scale of the image, and so on). For each scale, the plurality of edge properties may be the same or may be different. Then, based on the plurality of edge properties for the plurality of scales, a location of a text in the image may be determined.

According to various embodiments, the plurality of edge properties may include or may be an edge gradient property and/or an edge linearity property and/or an edge openness property and/or an edge aspect ratio property and/or an edge enclosing property and/or an edge count property.

According to various embodiments, the plurality of scales may include or may be a reduced scale and/or an original scale and/or an enlarged scale.

According to various embodiments, the image input circuit 102 may be configured to receive an image including a plurality of color components. The edge property determination circuit 104 may further be configured to determine the plurality of edge properties for each of the plurality of scales of the image for the plurality of color components of the image.

According to various embodiments, the text location determination circuit 106 may further be configured to determine the text location in the image based on a knowledge of text format and layout.

The knowledge of text format and layout may include or may be: a threshold on a projection profile and/or a threshold on a ratio between text line height and image height and/or a threshold on a ratio between text line length and the maximum text line length within the same scene image and/or a threshold on a ratio between the maximum variation and the mean of the projection profile of a text line and/or a threshold on a ratio between character height and the corresponding text line height and/or a ratio between inter-character distance within a word and the corresponding text line height.

According to various embodiments, the image input circuit 102 may be configured to receive an image including a plurality of pixels. Each edge property of the plurality of edge properties may include or may be, for each pixel of the plurality of pixels, a probability of text at a position of the pixel in the image. In other words, the edge properties may define a plurality of edge feature images for each color and each scale. Combining the edge features for one color and one scale may define a feature image for the one color and the one scale.

According to various embodiments, the text location determination circuit may be configured to determine for each pixel of the plurality of pixels a probability of text at a position of the pixel in the image based on the plurality of edge properties for the plurality of scales of the image. In other words: a probability map may be determined based on the edge properties, for example based on the feature images.

FIG. 1B shows a text detection device 110 according to various embodiments. The text detection device 110 may, similar to the text detection device 100 of FIG. 1A, include an image input circuit 102 configured to receive an image. The text detection device 110 may, similar to the text detection device 100 of FIG. 1A, further include an edge property determination circuit 104 configured to determine a plurality of edge properties for each of a plurality of scales of the image. The text detection device 110 may, similar to the text detection device 100 of FIG. 1A, further include a text location determination circuit 106 configured to determine a text location in the image based on the plurality of edge properties for the plurality of scales of the image. The text detection device 110 may further include an edge determination circuit 112, like will be described below. The text detection device 100 may further include a projection profile determination circuit 114, like will be described below. The image input circuit 102, the edge property determination circuit 104, the text location determination circuit 106, the edge determination circuit 112, and the projection profile determination circuit 114 may be coupled with each other, for example via a connection 116, for example an optical connection or an electrical connection, such as for example a cable or a computer bus or via any other suitable electrical connection to exchange electrical signals.

According to various embodiments the edge determination circuit 112 may be configured to determine edges in the image. The edge property determination circuit 104 may be configured to determine the plurality of edge properties based on the determined edges.

According to various embodiments, the projection profile determination circuit 114 may be configured to determine a projection profile based on the plurality of edge properties.

According to various embodiments, the text location determination circuit 106 may further be configured to determine the text location in the image based on the projection profile.

FIG. 1C shows a flow diagram 118 illustrating a text detection method according to various embodiments. In 120, an image may be received. In 122, a plurality of edge properties may be determined for each of a plurality of scales of the image. In 124, a text location in the image may be determined based on the plurality of edge properties for the plurality of scales of the image.

According to various embodiments the plurality of edge properties may include or may be an edge gradient property and/or an edge linearity property and/or an edge openness property and/or an edge aspect ratio property and/or an edge enclosing property and/or an edge count property.

According to various embodiments, the plurality of scales may include or may be a reduced scale and/or an original scale and/or an enlarged scale.

According to various embodiments, an image including a plurality of color components may be received. The plurality of edge properties may be determined for each of the plurality of scales of the image for the plurality of color components of the image.

According to various embodiments, the text location in the image may be determined based on a knowledge of text format and layout.

The knowledge of text format and layout may include or may be: a threshold on a projection profile and/or a threshold on a ratio between text line height and image height and/or a threshold on a ratio between text line length and the maximum text line length within the same scene image and/or a threshold on a ratio between the maximum variation and the mean of the projection profile of a text line and/or a threshold on a ratio between character height and the corresponding text line height and/or a ratio between inter-character distance within a word and the corresponding text line height.

According to various embodiments, an image including a plurality of pixels may be received. Each edge property of the plurality of edge properties may for each pixel of the plurality of pixels include or be a probability of text at a position of the pixel in the image.

According to various embodiments, for each pixel of the plurality of pixels a probability of text at a position of the pixel in the image may be determined based on the plurality of edge properties for the plurality of scales of the image.

According to various embodiments, the text detection method may further include: determining edges in the image. The plurality of edge properties may be determined based on the determined edges.

According to various embodiments, the text detection method may further include: determining a projection profile based on the plurality of edge properties.

According to various embodiments, the text location in the image may be determined based on the projection profile.

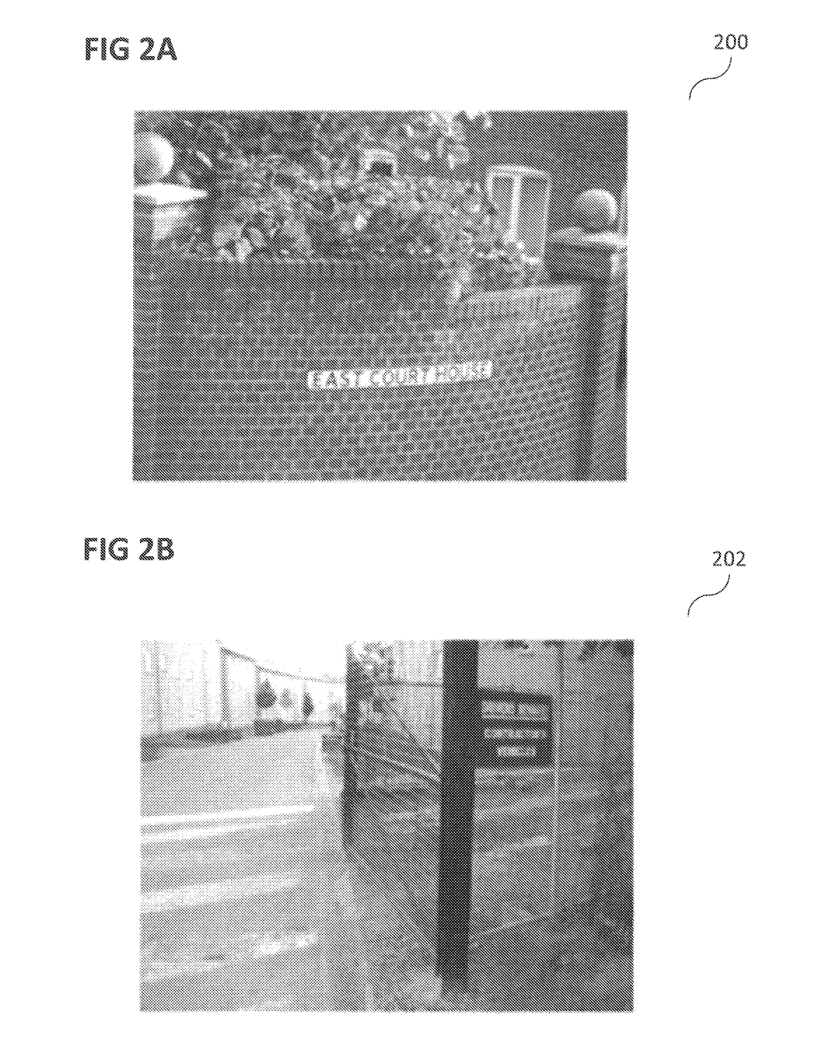

FIG. 2A shows a sample natural image 200 with text. FIG. 2B shows a further sample natural image 202 with text. The sample image 200 and the sample image 202 may be selected from a public benchmarking dataset.

Detecting text from scene images may be an important task for a number of computer vision applications. By recognizing the detected scene text many of which may be related to the names of roads, buildings, and other landmarks, as illustrated in FIG. 2A, users may get to know a new environment quickly. In addition, scene text may be related to certain navigation instructions as illustrated in FIG. 2B that may be helpful for autonomous navigation applications such as unmanned vehicle navigation and robotic navigation in urban environments. Furthermore, semantic information may be derived from the detected scene text which may be useful for the content-based image retrieval.

Commonly used scene text detection methods may be broadly classified into three categories, namely, texture-based methods, region-based methods, and stroke-based methods. Texture-based methods may classify image pixels based on different text properties such as high edge density and high intensity variation. Region-based methods may first group image pixels into regions based on specific image properties such as constant color and then classify the grouped regions into text and non-text. Stroke-based methods may make use of character strokes that usually have little stroke width variation. Though scene text detection has been studied extensively, it is still an unsolved problem due to the large variation of scene text in term of text sizes, orientations, image contrast, scene contexts, etc. Two competitions have been held to record advances in scene text detection. The competitions are based on a benchmarking dataset that consists of 509 natural images with text. The low performance achieved (top recall at 67% and top precision at 62%) also suggests that there is still a big room for improvement, especially compared with another closely related area that deals with the detection and recognition of scanned document text.

According to various embodiments, devices and methods may be provided for scene text detection technique which may make use of knowledge of text layout and several discriminative edge features. For example, the devices and methods according to various embodiments may implement a multi-scale detection architecture that may be suitable for the text detection from natural images. Furthermore, according to various embodiments, six discriminative edge features may be designed that can be integrated to differentiate edges of text and non-text objects consistently. Compared with pixel-level texture or region features, the edge features according to various embodiments may be more capable of capturing the prominent shape characteristics associated with the text. In addition, the combination of the six edge features may be more discriminative than the usage of the stroke width feature alone. The devices and methods according to various embodiments may outperform most commonly used methods and may achieve a superior detection precision and recall of 81% and 66%, respectively, for a widely used public benchmarking dataset.

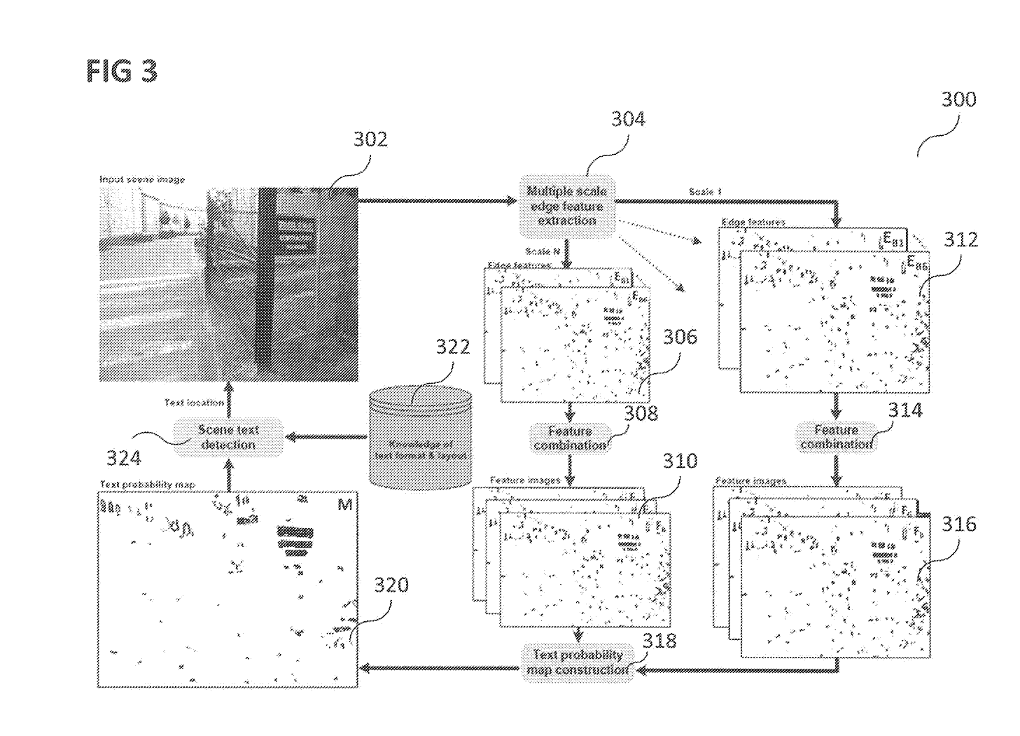

FIG. 3 shows a framework 300 of the scene text detection system devices and methods according to various embodiments. The scene text detection devices and methods may be implemented within a blackboard (or a whiteboard) architectural model as illustrated in FIG. 3. Due to issue with displaying the details of a blackboard architectural model, a whiteboard example is provided instead in FIG. 3 for ease of illustration. In the following, the framework 300 of FIG. 3 will be described. Given a scene image 302, image edges may first be detected under the hypothesis of being either text edges or non-text edges. The target may be to identify text edges correctly based on which scene text can be further located. Two categories of knowledge sources may be integrated. One category may be predefined that is related to knowledge of text layout 322 such as the text line height relative to the image height. The other category may be composed of six discriminative edge features (which may also be referred to as edge properties) each of which specifies the probability of whether an edge is a text edge or non-text edge from one specific view. Several integration strategies may be implemented. This is illustrated in 314 for an exemplary first scale and in 308 for an exemplary N-th scale. It will be understood that any number of scales may be present. The number of scales used can be pre-defined, where larger scale images are helpful for detection of text of small size and smaller scale images are helpful for detection of text of large size. Though using a larger number of scales often produces better text detection accuracy, it also increases the computational loads and so accuracy and efficiency should be compromised depending on practical requirements. The corresponding processing may be performed for each scale. In 318, edge features of different scales (like illustrated by box 304) from different color component images may be combined into a text probability map 320, where edges of scene text may be enhanced whereas those of non-text objects may be suppressed. For example, edge features 312 for an exemplary first scale may be combined in 314 to feature images 316 for the first scale (for example for red, green and blue color components), and edge features 306 for an exemplary N-th scale may be combined in 308 to feature images 310 (for example for red, green and blue color components) for the N-th scale. The scene text may finally be detected in 324 through the combination of the text probability map and the predefined text layout rules 322. All modules shown in FIG. 3 will be discussed in more detail below.

According to various embodiments, devices and methods may be based on structural edge features, and image edges may be first detected. The edges may be detected by using any commonly known edge detector, for example Canny's edge detector, which may be robust to uneven illumination and capable of connecting edge pixels of the same object. The detected edges may then be pre-processed to facilitate the ensuing edge feature extraction. First, edge pixels, for example all edge pixels, may be removed, for example if they are connected to more than two edges pixels within a 3×3 8-connectivity neighborhood window. This may break edges at the edge pixels that have more than 2 branches which may be detected from noisy background or touching characters. Next, image edges may be labeled through connected component analysis and those with a small size may be removed. For example, the threshold size may be set at 20 as text edges may usually consist of more than 20 pixels.

One or more edge features (for example six edge features) may then be derived from edges, for example from edges of each color component image at each image scale. Each derived edge feature may give the probability of whether the edge is a text edge or non-text edge which may later be integrated to build a text probability map. It will be understood that not all of the six edge features need to be present, but rather at least one of them may be present. However, any number of edge features may be present, even all six edge features, or further edge features not described below may be present.

The first (edge) feature E₁, which may also be referred to as an edge gradient property, may capture the image gradient as follows:

$${E}_{1} = \frac{μ ( {G}_{e} )}{σ ( {G}_{e} )} \qquad [ 1 ]$$

where Gₑ may be a vector that may store the gradient of all edge pixels, μ(Gₑ) may denote the mean of Gₑ, and σ(Ge) may denote the standard deviation of Ge. Compared with non-text edges, text edges may often have a larger value of E₁, because text edges may usually have higher but more consistent image gradient (and hence a larger numerator and a smaller denominator in E₁).

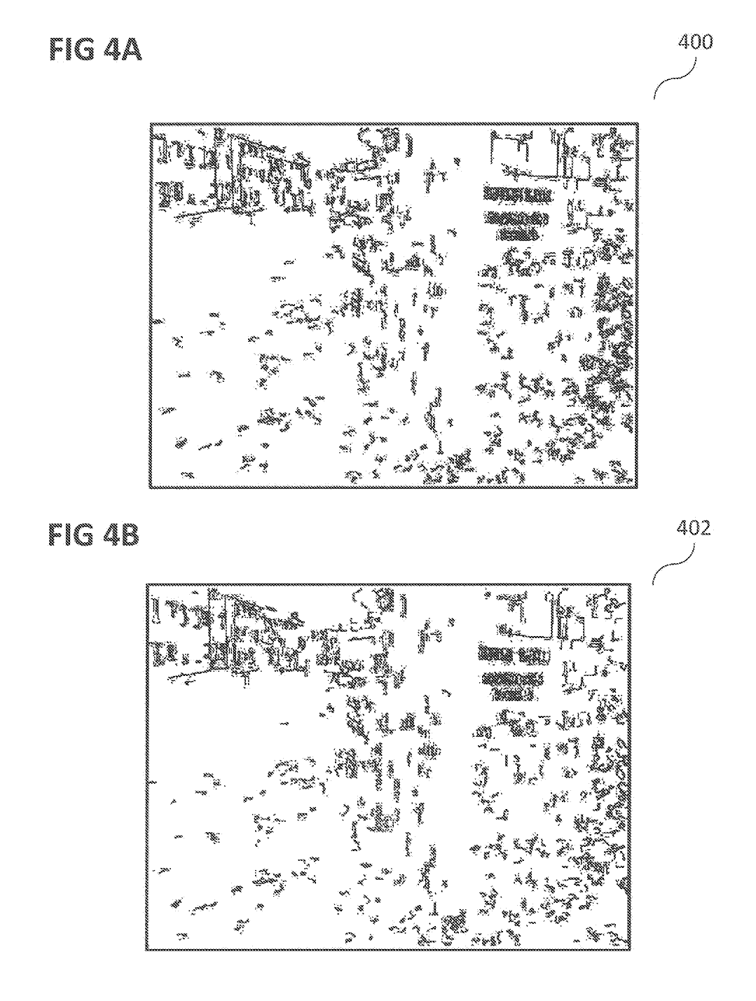

FIG. 4A shows the determined first feature image 400 of the first edge gradient feature (for red color component image at original scale) for the sample image of FIG. 2B.

The second (edge) feature E₂, which may also be referred to as an edge linearity property, may capture the edge linearity that may be estimated by the distance between an edge pixel and its counterpart. For each edge pixel E(xᵢ, yᵢ) of an edge E, its counterpart pixel E(x′ᵢ, y′ᵢ) may be detected by the nearest intersection between E and a straight line L that passes through E(xᵢ, yᵢ) and has the same orientation as that of the image gradient at E(xᵢ, yᵢ). It should be noted that E(x′ᵢ, y′ᵢ) may be determined by the nearest intersection to E(xᵢ, yᵢ) as more than one intersection may be detected between E and L. The second feature is defined as follows:

$${E}_{2} = \frac{Max ( H ( d ) )}{argmaxMax ( H ( d ) ) / Min ( {E}_{w} , {E}_{h} )} \qquad [ 2 ]$$

where H(d) may be the histogram of the distance d between an edge pixel and its counterpart. The H(d) of an edge is determined as follows. For each edge pixel p, a straight line 1 is determined that passes through p along the orientation of the image gradient at p. The distance between p and the first probed edge pixel (by 1 in either direction), if existed, is counted as one stroke width candidate and used to update the H(d). The H(d) of the edge is constructed when all edge pixels are examined as described. Max(H(d) may return the peak frequency of d and argmaxMax(H(d)) may return the d with the peak frequency. E_{w} may denote the width of the edge, and Eₕ may denote the height of the edge. Compared with non-text edges, text edges may usually have a much larger value of E, due to the small variation of the character stroke width and a small ratio between the stroke width and the edge size.

FIG. 4B shows the determined second feature image 402 of the second stroke width feature (for red color component image at original scale) for the sample image of FIG. 2B.

The third (edge) feature E₃, which may also be referred to as an edge openness property, may capture the edge openness. As described above, each edge may have a pair of ending pixels if it is not closed and otherwise zero (for example zero ending pixels) after the edge breaking. The edge openness may be evaluated based on the Euclidean distance between the ending pixels of an edge component at (x₁, y₁) and (x₂, y₂) as follows:

$${E}_{3} = \{ \begin{matrix}1 , & if E is closed \\ 1 - \frac{\sqrt{{( {x}_{1} - {x}_{2} )}^{2} + {( {y}_{1} + {y}_{2} )}^{2}}}{MXL} , & Otherwise\end{matrix} \qquad [ 3 ]$$

where MXL may denote the major axis length of the edge component (for normalization). Compared with non-text edges, text edges may usually have a larger value of E3 as text edges may often be closed or their ending pixels are close.

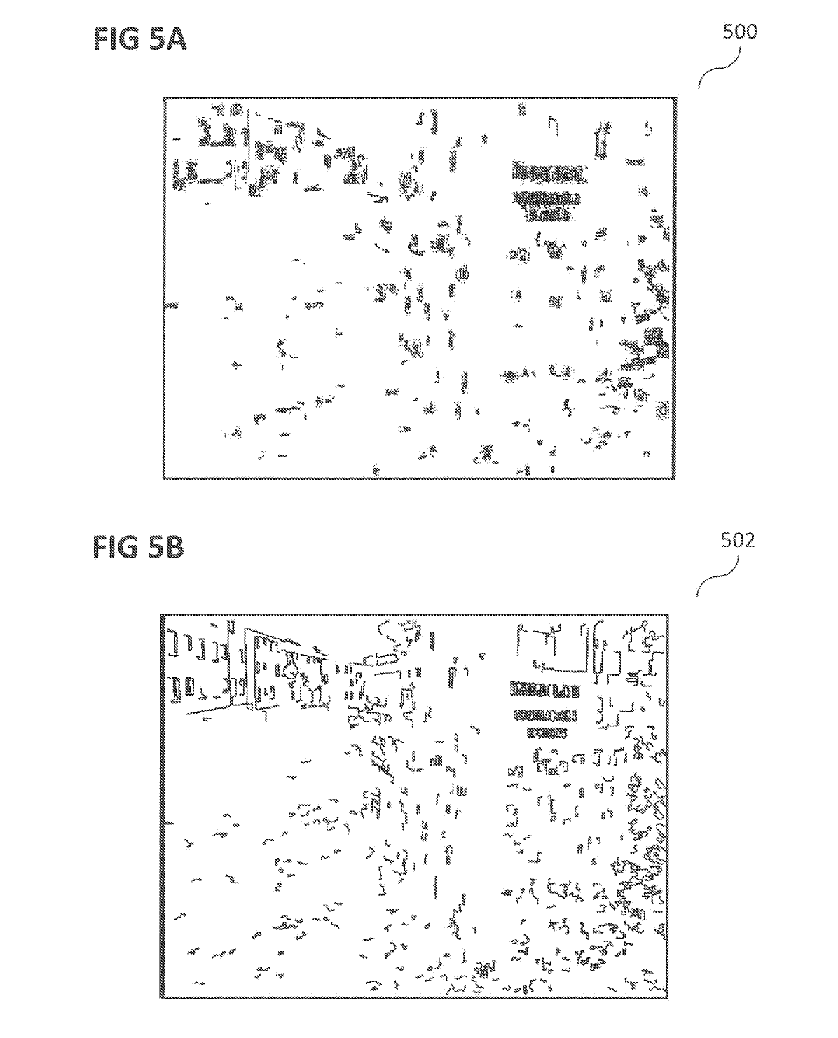

FIG. 5A shows the determined third feature image 502 of the third edge openness feature (for red color component image at original scale) for the sample image of FIG. 2B.

The fourth (edge) feature E₄, which may also be referred to as an edge aspect ratio property, may be defined by the edge aspect ratio. As scene text may be captured in arbitrary orientations, E₄ may be defined by the ratio between the minor axis length and major axis length of the image edge as follows:

$${E}_{4} = \frac{MNL}{MXL} \qquad [ 4 ]$$

where MXL may denote the major axis length of the edge, and MNL may denote the minor axis length of the edge. Compared with non-text edges, text edges may usually have a larger value of E₄ because its MNL and MXL may usually be close to each other.

FIG. 5B shows the determined fourth feature image 502 of the fourth edge aspect ratio feature (for red color component image at original scale) for the sample image of FIG. 2B.

The fifth (edge) feature E₅, which may also be referred to as an edge enclosing property, may capture the edge enclosing property that each text component usually does not enclose too many other isolated text components. It may be defined as follows:

$${E}_{5} = \{ \begin{matrix}1 , if t < T \\ 0 , Otherwise\end{matrix} \qquad [ 5 ]$$

where t may denote the number of the edge components enclosed by the edge component under study. T may be a number threshold that may for example be set at 4 (as each text edge for example seldom may enclose more than 4 other text edges).

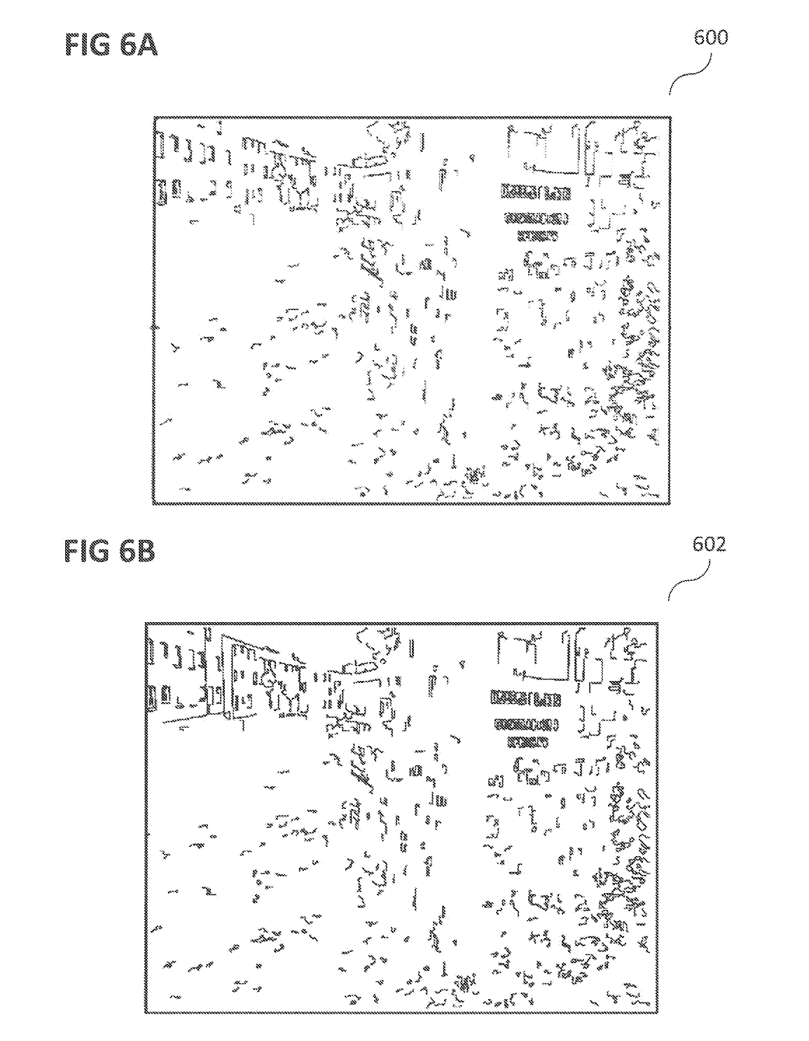

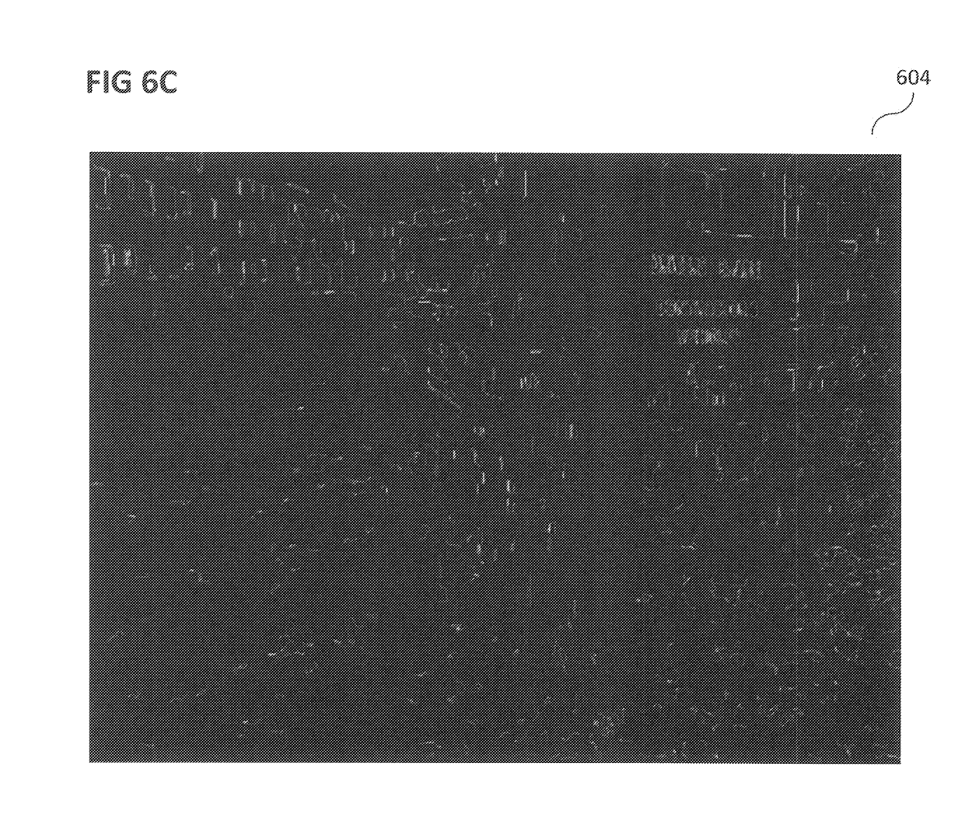

FIG. 6A shows the fifth feature image 602 of the fifth edge enclosing feature (for red color component image at original scale) for the sample image in FIG. 2B. FIG. 6C further illustrates the fifth edge enclosing feature as shown in FIG. 6A in a blackboard representation 604.

The sixth (edge) feature E₆, which may also be referred to as an edge count property, may be based on the observation that each character may usually have more than one stroke (and hence two edge counts) in either horizontal or vertical direction. E₆ may be evaluated based on the number of rows and columns of the edge that have more than two edge counts as follows:

$${E}_{6} = {e}^{\frac{{\sum }_{i = 1}^{{E}_{w}} f ( {cn}_{i} ) + {\sum }_{j = 1}^{{E}_{n}} f ( {cn}_{j} )}{{E}_{w} + {E}_{n}}} \qquad [ 6 ]$$

where the function f(cn) may be defined as follows:

$$f ( cn ) = \{ \begin{matrix}1 if cn > 2 \\ 0 Otherwise\end{matrix}$$

where cnᵢ may denote edge counts of the i-th edge row, and cnⱼ may denote edge counts of the j-th edge column. The edge count along one edge row (or edge column) is the number of intersections between the edge pixels and a horizontal (or vertical) scan line along that edge row. Note that only one intersection is counted when multiple connected and continuous horizontal (or vertical) edge pixels intersect with the horizontal (or vertical) scan line. Compared with non-text edges, text edges may often have a larger value of E6 as they usually have a larger number edge counts.

FIG. 6B shows the sixth feature image 602 of the six edge count feature (for red color component image at original scale) for the sample image of FIG. 2B.

Several integration strategies may be implemented to combine the derived (edge) features into a text probability map. Instead of using edge features from the grayscale image, edge features from three color component images may be combined, i.e., E_{R1}, . . . , E_{R6} (representing the six features related to the red color component), E_{G1}, . . . , E_{G6} (representing the six features related to the green color component), and EB1, . . . , E_{B6} (representing the six features related to the blue color component), so as to obtain a feature image for each scale and each color as illustrated in FIG. 3 (for example in FIG. 3, feature images for a first scale are shown in 316 for red, green and blue, and feature images for an N-th scale are shown in 310 for red, green and blue). The reason may be that some text-specific edge features may often be more prominent within certain color component images compared with those within the grayscale image. In addition, edge features of different scales may be combined as illustrated in FIG. 2 because some text-specific edge features may be best captured at certain specific image scale. In the proposed system, six image scales including 2, 1, 0.8, 0.6, 0.4, and 0.2 of the original image scale, respectively, may be implemented. For example, 2 may be an enlarged scale. For example, 0.8, 0.6, 0.4, and 0.2 may be reduced scales. The scales 2 and 0.2 may be used to detect scene text with an extra-small and extra-large text size, respectively. The processing at different scales is described in Equations 7 and 8 in the ensuing description. For example, six edge features are first extracted at one specific scale of one specific color channel image. A feature image is then determined by multiplying the six edge features as described in Equation 7. Three feature images of three color channel images at one specific scale is then integrated as one feature image through max-pooling, and finally, the max-pooled feature images at different scales are averaged to form a text probability map as described in Equation 8. Images at different scales may be obtained through resizing of the image loaded at the original image scale, where the image resizing may be implemented through bicubic interpolation of neighboring image pixels.

As each edge feature may give the probability of being text edges, a feature image may first be determined through the multiplication of the six edge features from each color component image at one specific image scale as follows:

F_{i,j}=Πₖ₌₁⁶E_{i,j,k} [7]

where E_{i,j,k}, i=1, . . . 6, j=1, . . . , 3, k=1, . . . , 6 may denote the k-th edge feature that is derived from edges of the j-th color component image at the i-th image scale. For each color scene image at one specific image scale, three feature images, i.e., F_{R} (for red), F_{G} (for green), and F_{B} (for blue) as illustrated in FIG. 3, may thus be determined through the combination of the edge features derived from three color component images.

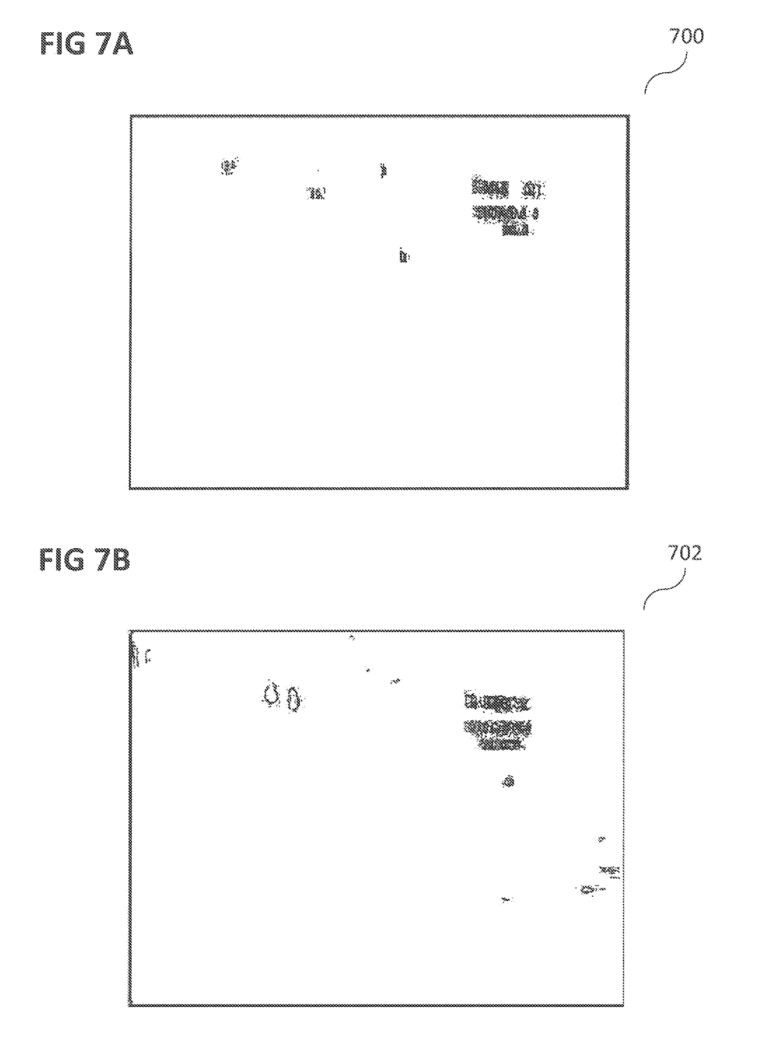

FIG. 7A shows the determined feature image 700, for example the edge feature image at one specific scale (for red color component image at original scale) for the sample image in FIG. 2B, where text edges are kept properly whereas non-text edges are suppressed properly.

Once the feature image is determined, each edge may further be smoothed by its neighboring edges that are detected based on knowledge of text layout. For example, for each edge E, its neighboring edges Eₙ may be detected based on three layout criteria including: 1) the centroid distances between E and Eₙ in both horizontal and vertical direction is smaller than half of the sum of their major axis length; 2) the centroid of E/Eₙ must be higher/lower than the lowest/highest pixel of Eₙ/E in both horizontal and vertical directions; 3) the width/height ratio of E and Eₙ should lie within a certain range (for example [⅛ 8]). Once Eₙ is determined, the value of E may be replaced by the maximum value of Eₙ if it is larger than the maximum value of Eₙ and otherwise may keep unchanged. The smoothing may help to suppress isolated non-text edges that have a high feature value. It may have little effects on edges of scene text as characters often appear close to each other and their edges usually have a high probability value.

For example, finally, the feature images of different color component images at different scales may be integrated into a text probability map by max-pooling and averaging as follows:

$$M = \frac{1}{s} {\sum }_{i = 1}^{s} {f}_{max} ( {F}_{i , j} ) \qquad [ 8 ]$$

where S may denote the number of image scales and F_{i,j} may be the feature image in Equation (7). As Equation (8) shows, the three feature images at each image scale may first be combined through max-pooling denoted by f_{MAX}( ) that may return the maximum of the three feature images at each edge pixel. The max-pooling may ensure that the edge features that best capture the text-specific shape characteristics may be preserved. In addition, an averaging may be implemented to make sure that the edge features with a prominent feature value at different scales can be preserved as well.

FIG. 7B shows the final(ly) determined text probability map 700 for the sample image of FIG. 2B. As FIG. 7B shows, text edges within the constructed text probability map may consistently get high response whereas the responses of non-text edges may be suppressed properly.

With the determined text probability map, scene text may be located based on a set of predefined text layout rules including:
1) the projection profile of the text probability map has the maximum variance at the orientation of text lines;
2) the ratio between text line height and image height should not be too small;
3) the ratio between text line length and the maximum text line length within the same scene image should not be too small;
4) the ratio between the maximum variation (evaluated by |P₁(i+1)−P₁(i−1)|), like will be described in more detail below, and the mean of the projection profile of a text line cannot be too small because the projection profile of text lines usually has sharp variation at the top line and base line positions;
5) the ratio between character height and the corresponding text line height should not be too small; and
6) the ratio between inter-character distance within a word and the corresponding text line height lies within a specific range.

To integrate knowledge of text layout, multiple projection profiles P at a step-angle of 1 degree are first determined. The orientation of text lines may be determined by the projection profile P₁ with the maximum variance as specified in Rule 1. Multiple text line candidates are then determined by sections within P₁ whose values are larger than the mean of P₁. The projection profile of an image is an array that stores the accumulated image value along one specific direction. Take the projection profile along the horizontal direction as an example. The project profile will be an array (whose element number is equal to the image height) where each array element stores the accumulated image value along one image row.

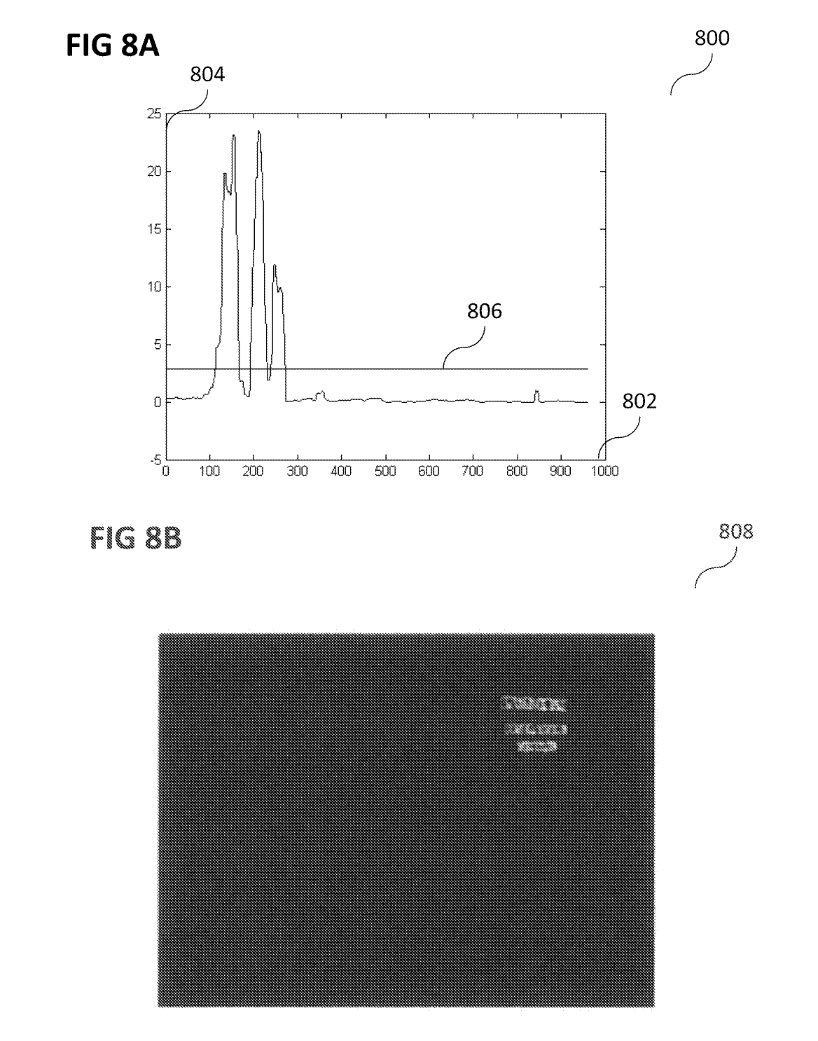

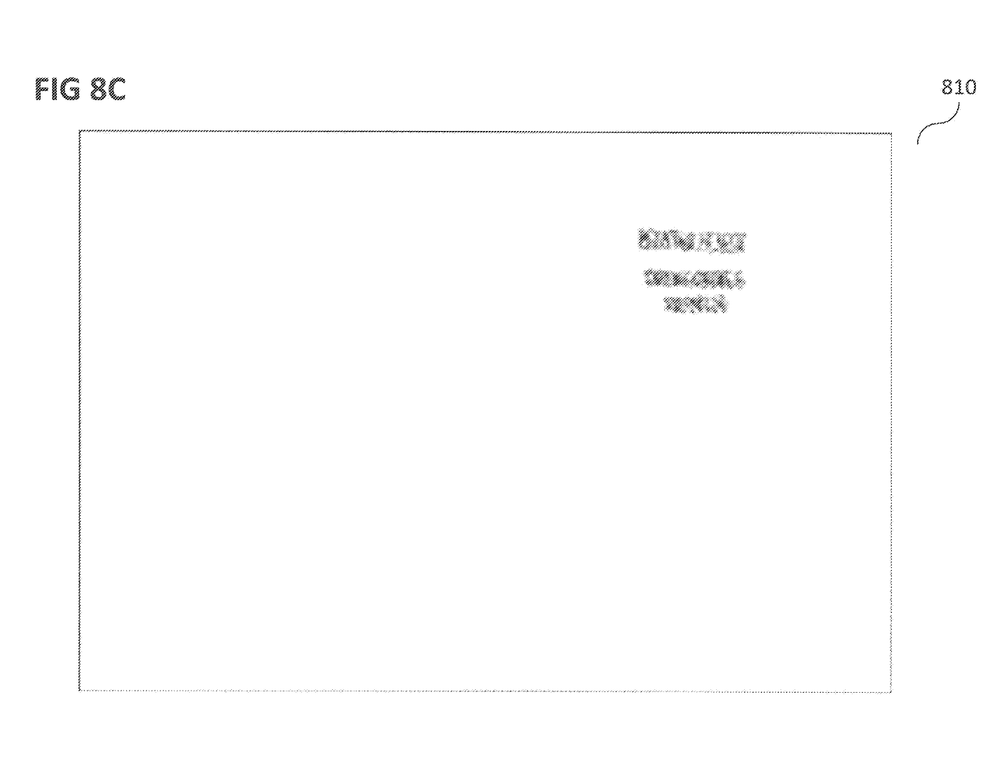

FIG. 8A illustrates the edge feature image at one specific scale and shows a diagram 800 illustrating the P₁ for the text probability map shown in FIG. 7B. The horizontal axis 802 indicates the number of line in the image, and the vertical axis 804 illustrates the projection profile for this line. The horizontal line 806 shows the mean of P₁.

The true text lines may then further be identified based on Rules 2, 3, and 4. First, sections with an ultra-small length may be removed with a ratio threshold of 1/200, as text line height is much larger than 1/200 of image height. Next, sections with an ultra-small section mean may be removed with a ratio threshold of 1/20, as text line length is much larger than 1/20 of the maximum text line length. Last, sections with no sharp variation may be removed with a threshold of 1/10, as the maximum variation for a text line is much larger than 1/10 of the mean of the corresponding candidate section.

The detected text lines may then be binarized to locate words. The threshold for each pixel within the detected text lines may be estimated by the larger between a global threshold T₁ and a local threshold T₂(x, y) that may be estimated as follows:

$$\{ \begin{matrix}{T}_{1} = \frac{M}{\sum M > 0} \\ {T}_{2} = {μ}_{w} ( M ( x , y ) ) - k {σ}_{w} ( M ( x , y ) )\end{matrix}$$

where T₁ may be the mean of all edge pixels with a positive value that usually lies between the probability values of text and non-text edges. It may be used to exclude most non-text edges within the detected text lines. T₂(x, y) may be estimated, for example by Niblack's adaptive thresholding method within a neighborhood window.

Words may finally be located based on Rules 5 and 6. First, the binary edges with an extra-small height may be removed with a ratio threshold at 0.4 because character height is usually much larger than 0.4 of text line height. Next, the binary edges with an extra-small distance to their nearest neighbor may be removed with a ratio threshold at 0.2 because inter-character distance is usually smaller than 0.2 of text line height. Finally, words may be located by grouping the remaining binary edge components whose distance to the nearest neighbor is larger than 0.2 of the text line height.

FIG. 8B shows the finally determined text probability map (for example shown as a blackboard model illustration) and shows an illustration 808 of the filtered binary edge components for the detected text lines shown in FIG. 8A.

FIG. 8C shows the final determined text probability map 810 in a white board illustration.

The devices and methods according to various embodiments may be evaluated over a public dataset that was widely used for scene text detection benchmarking and has also been used in the two established text detection contests.

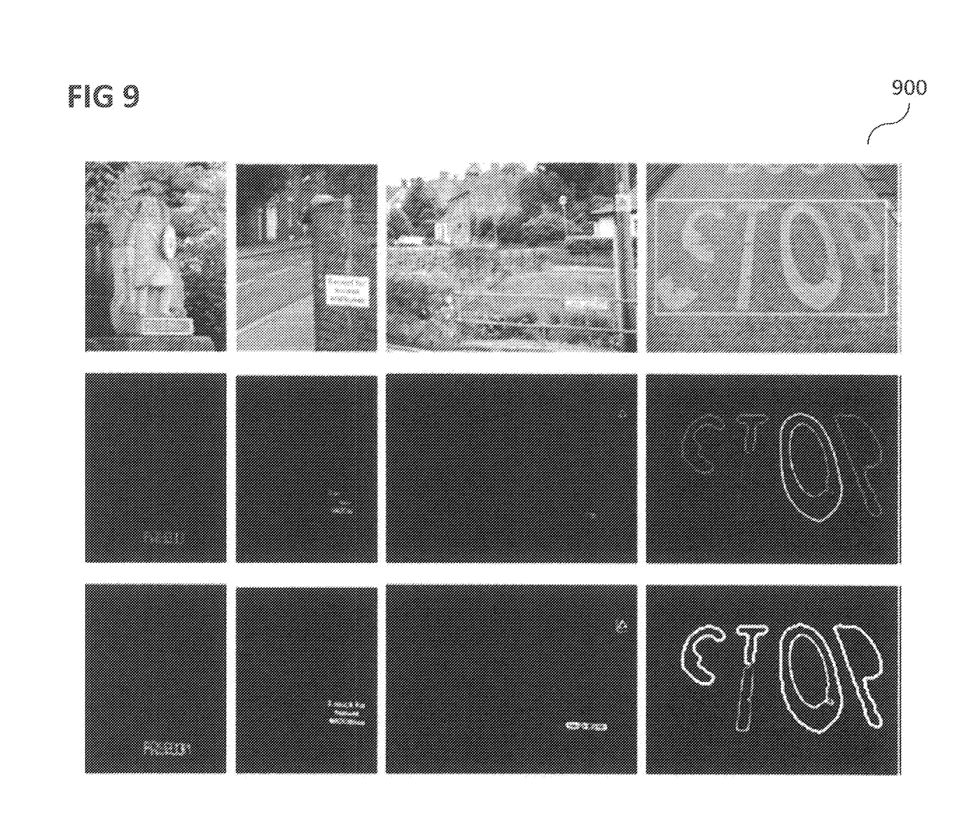

FIG. 9 shows an illustration 900 of the results of devices and methods according to various embodiments, with several natural images in a benchmarking dataset.

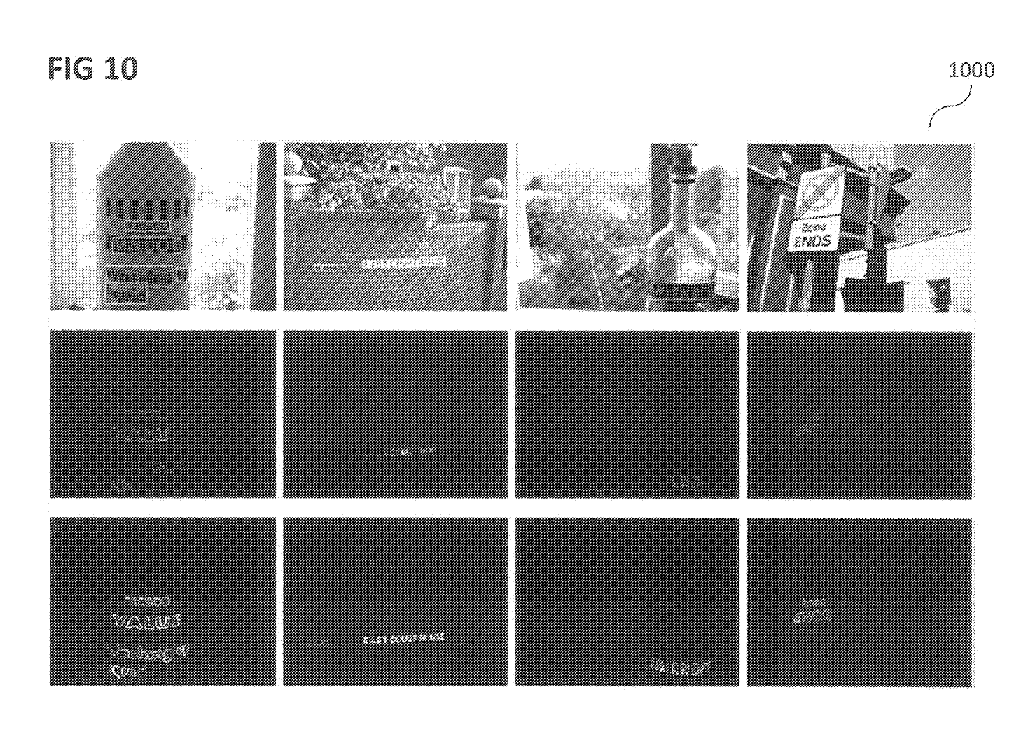

FIG. 10 shows a further illustration 1000 of devices and methods according to various embodiments, with several natural images in a benchmarking (publicly available) dataset.

FIG. 9 and FIG. 10 illustrate experimental results where the three rows show eight sample scene images within the benchmarking dataset (detection results are labeled by rectangles), the corresponding text probability maps, and the filtered binary edge components, respectively. As FIG. 9 shows, the devices and methods according to various embodiments may be tolerant to the low image contrast as shown in the first sample image which can be explained by the 2nd to 6th used structure-level edge features. In addition, the devices and methods according to various embodiments may be capable of detecting scene text that has an extra-small or extra-large size as illustrated in the second, third and fourth sample images. Such capability may be explained by the multiple-scale detection architecture as illustrated in FIG. 3 where the text-specific edge features become salient at a high or low image scale for scene text with an extra-small or extra-large size. Furthermore, the devices and methods according to various embodiments may be tolerant to the scene context variation as illustrated in the four sample images where text is captured under far different contexts. However, the combination of the six edge features from different color component images at different scales may be capable of differentiating edges of text and non-text objects consistently.

Devices and methods according to various embodiments may be used in different applications such as robotic navigation, unmanned vehicle navigation, business intelligence, surveillance, and augmented reality. For example, the devices and methods according to various embodiments may be used in detecting and recognizing numerals or numbers printed or inscribed on an article, for example, a container, a box or a card.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

What is claimed is:

1. A text detection device comprising:
an image input circuit configured to receive an image;
an edge property determination circuit configured to determine a plurality of edge properties for each of a plurality of scales of the image; and
a text location determination circuit configured to determine a text location in the image based on the plurality of edge properties for the plurality of scales of the image.

2. The text detection device of claim 1, wherein the plurality of edge properties comprises a plurality of edge properties selected from a list of edge properties consisting of:
an edge gradient property;
an edge linearity property;
an edge openness property;
an edge aspect ratio property;
an edge enclosing property; and
an edge count property.

3. The text detection device of claim 1, wherein the plurality of scales comprises a plurality of scales selected from a list of scales consisting of:
a reduced scale;
an original scale; and
an enlarged scale.

4. The text detection device of claim 1,
wherein the image input circuit is configured to receive an image comprising a plurality of color components; and
wherein the edge property determination circuit is further configured to determine the plurality of edge properties for each of the plurality of scales of the image for the plurality of color components of the image.

5. The text detection device of claim 1, wherein the text location determination circuit is further configured to determine the text location in the image based on a knowledge of text format and layout.

6. The text detection device of claim 1,
wherein the image input circuit configured to receive an image comprising a plurality of pixels; and
wherein each edge property of the plurality of edge properties comprises for each pixel of the plurality of pixels a probability of text at a position of the pixel in the image.

7. The text detection device of claim 6, wherein the text location determination circuit is configured to determine for each pixel of the plurality of pixels a probability of text at a position of the pixel in the image based on the plurality of edge properties for the plurality of scales of the image.

8. The text detection device of claim 1, further comprising:
an edge determination circuit configured to determine edges in the image;
wherein the edge property determination circuit is configured to determine the plurality of edge properties based on the determined edges.

9. The text detection device of claim 1, further comprising a projection profile determination circuit configured to determine a projection profile based on the plurality of edge properties.

10. The text detection device of claim 9, wherein the text location determination circuit is further configured to determine the text location in the image based on the projection profile.

11. A text detection method comprising:
receiving an image;
determining a plurality of edge properties for each of a plurality of scales of the image; and
determining a text location in the image based on the plurality of edge properties for the plurality of scales of the image.

12. The text detection method of claim 11, wherein the plurality of edge properties comprises a plurality of edge properties selected from a list of edge properties consisting of:
an edge gradient property;
an edge linearity property;
an edge openness property;
an edge aspect ratio property;
an edge enclosing property; and
an edge count property.

13. The text detection method of claim 11, wherein the plurality of scales comprises a plurality of scales selected from a list of scales consisting of:
a reduced scale;
an original scale; and
an enlarged scale.

14. The text detection method of claim 11,
wherein an image comprising a plurality of color components is received; and
wherein the plurality of edge properties is determined for each of the plurality of scales of the image for the plurality of color components of the image.

15. The text detection method of claim 11, wherein the text location in the image is determined based on a knowledge of text format and layout.

16. The text detection method of claim 11,
wherein an image comprising a plurality of pixels is received; and
wherein each edge property of the plurality of edge properties comprises for each pixel of the plurality of pixels a probability of text at a position of the pixel in the image.

17. The text detection method of claim 16, wherein for each pixel of the plurality of pixels a probability of text at a position of the pixel in the image is determined based on the plurality of edge properties for the plurality of scales of the image.

18. The text detection method of claim 11, further comprising:
determining edges in the image;
wherein the plurality of edge properties is determined based on the determined edges.

19. The text detection method of claim 11, further comprising determining a projection profile based on the plurality of edge properties.

20. The text detection method of claim 19, wherein the text location in the image is determined based on the projection profile.
